(19) United States
(12) Patent Application Publication
(10) Pub. No.: US 2004/0015602 A1
(43) Pub. Date: Jan. 22, 2004

(54) Network bandwidth allocation and access method and apparatus

(75) Inventors: Seth Goldhammer, Boulder, CO (US); Chris Markle, Denver, CO (US)

Correspondence Address: SHERIDAN ROSS PC, 1560 BROADWAY, SUITE 1200, DENVER, CO, 80202

(73) Assignee: Roving Planet, Inc.

(21) Appl. No.: 10/199,152

(22) Filed: Jul. 19, 2002

(51) Int. Cl. G06F 15/16

(52) U.S. Cl. 709/235

(57) ABSTRACT

The present invention allows bandwidth available on a network to be dynamically controlled. In particular, the present invention allows the maximum bandwidth available to an end client to be limited when the network is congested, thereby preserving bandwidth for higher priority data. In addition, the present invention allows even low priority data to be sent with the benefit of the full bandwidth then available on the network when the network is not congested. In addition, the invention may be used to control access to a computer network by known and unknown users.

### FIELD OF THE INVENTION

The present invention relates to controlling access and available bandwidth on a computer network. In particular, the present invention relates to altering the bandwidth available to a client in response to network conditions.

### BACKGROUND OF THE INVENTION

Access to computer networks is increasingly important to the operation of business enterprises and to individuals. Therefore, there is a demand for access to computer networks at almost any location where people congregate. For example, retail businesses, such as coffee shops, can provide network access both for the use of enterprise employees in running the business, and for the use of customers. In addition to the increasing need to obtain information wherever a computer user might be, the demand for public access to computer networks has increased, particularly with the advent of wireless access points. However, network congestion resulting from public access to a network can interfere with the business operations of the enterprise. Therefore, although business enterprises can often realize a competitive advantage by providing public access to the enterprise's network infrastructure, business enterprises have been reluctant to allow such access.

In order to ensure that the primary users (e.g., enterprise employees), have adequate access to the bandwidth provided by an enterprise network, static bandwidth partitioning schemes have been used. According to such schemes, a certain proportion of the available bandwidth is reserved for use by employees of the enterprise, and a certain proportion is provided for use by other users (e.g., members of the public). However, such static bandwidth partitioning schemes could be improved upon. For example, when network traffic is light, neither employees of the business enterprise nor public users are able to access the full bandwidth of the network connection.

Another solution for ensuring that adequate bandwidth is preserved for specific purposes is to provide a separate network for different classes of users. However, the provision of multiple networks for different classes of users results in the duplication of infrastructure, which in turn results in the incurrence of expenses that might otherwise be avoided. In addition, where such networks provide wireless access points, the provision of multiple networks may be complicated or prevented because of interference between the frequencies used by wireless access points associated with different networks and operating in the same general area.

### SUMMARY OF THE INVENTION

The present invention is directed to the allocation of bandwidth on a computer network. In particular, the present invention is directed to dynamically allocating bandwidth such that end clients having a high priority rating are provided with a higher bandwidth allocation as compared to end clients having a lower priority rating when the computer network is congested. Furthermore, the present invention allows an end client with a relatively low priority rating to benefit from the full bandwidth available on the computer network when that network is not congested.

In accordance with an embodiment of the present invention, a method for throttling or controlling bandwidth provided to end clients by a computer network is disclosed. According to the method, end clients may be provided with different priority ratings. In response to the detection of congestion on the computer network, the end clients having relatively high priority ratings may utilize all of the available bandwidth, while the bandwidth allocated to end clients having relatively low priority ratings is limited to an amount that is less than the maximum available bandwidth. When congestion is not present on the network, both those end clients having a relatively low priority rating and those end clients having a relatively high priority rating have access to the full bandwidth available on the network.

In accordance with another embodiment of the present invention, the priority rating of an end client is determined by one or more factors. For example, the user associated with the end client, the application in connection with which bandwidth on the network is requested, and the organization with which the user is associated, may be considered in assigning a priority rating. Furthermore, such factors may be considered individually or in combination to determine the priority rating of an end client.

In accordance with still another embodiment of the present invention, the bandwidth allocation provided to an end client may be altered by selectively queuing packets of data associated with that end client. For example, a packet of data being transmitted over the computer network to an end client having a low priority rating while the network is congested may be placed in a queue before that data is provided to the end client. The minimum amount of time that the data is maintained in the queue can vary, depending on the priority rating of the end client. For example, different priority ratings may have different associated queue times.

In accordance with still another embodiment of the present invention, the allocation of bandwidth to a client may be controlled by adjusting the frame size of data packets. In particular, by adjusting the frame size of data packets associated with an end client, the maximum effective bandwidth available to that end client can be controlled. In accordance with still another embodiment of the present invention, the transmission control protocol (TCP) receive window size associated with an end client can be adjusted to allocate the bandwidth available to an end client.

In accordance with yet another embodiment of the present invention, a server computer having programming code for providing dynamic bandwidth control on an associated computer network is provided. The server computer may allocate bandwidth according to a priority rating of an end client. In particular, when the associated computer network is congested, an end client with a relatively low priority will be provided with less than the maximum available bandwidth, while an end client with a high priority may have access to all of the available bandwidth. When the computer network is not congested, both high and low priority end clients may have access to all of the available bandwidth.

In order to control the bandwidth allocated to an end client, the server computer may provide data storage in which data packets transmitted over the computer network in connection with an end client having a relatively low priority may be queued when the network is congested. In addition, a wireless access point may be provided. Alternatively or in addition, bandwidth may be allocated by altering the frame size of data packets sent to a low priority end client. Bandwidth may also be allocated by adjusting the TCP receive window size associated with an end client. Each bandwidth allocation server associated with the network may control one or more access points. In addition, the functions of the server computer may be performed using a number of physical devices.

Additional advantages of the present invention will become readily apparent from the following discussion, particularly when taken together with the accompanying drawings.

### BRIEF DESCRIPTION OF THE DRAWINGS

FIG. 1 is a block diagram depicting a computer network incorporating a dynamic bandwidth allocation system in accordance with an embodiment of the present invention;

FIG. 2 is a functional block diagram depicting relationships between various components of a bandwidth allocation system in accordance with an embodiment of the present invention;

FIG. 3 is a block diagram of an end client in accordance with an embodiment of the present invention;

FIG. 4 is a block diagram of a central site director agent in accordance with an embodiment of the present invention;

FIG. 5 is a block diagram of a central site director engine in accordance with an embodiment of the present invention;

FIG. 6 is a functional flow diagram depicting access control functions of a bandwidth allocation system in accordance with an embodiment of the present invention;

FIG. 7 is a flow chart depicting the allocation of bandwidth in accordance with an embodiment of the present invention;

FIG. 8 is a flow chart depicting the allocation of bandwidth in accordance with another embodiment of the present invention;

FIG. 9 is flow chart depicting the allocation of bandwidth in accordance with another embodiment of the present invention; and

FIGS. 10A and 10B depict tables that may be used in determining the priority of an end client in accordance with an embodiment of the present invention.

### DETAILED DESCRIPTION

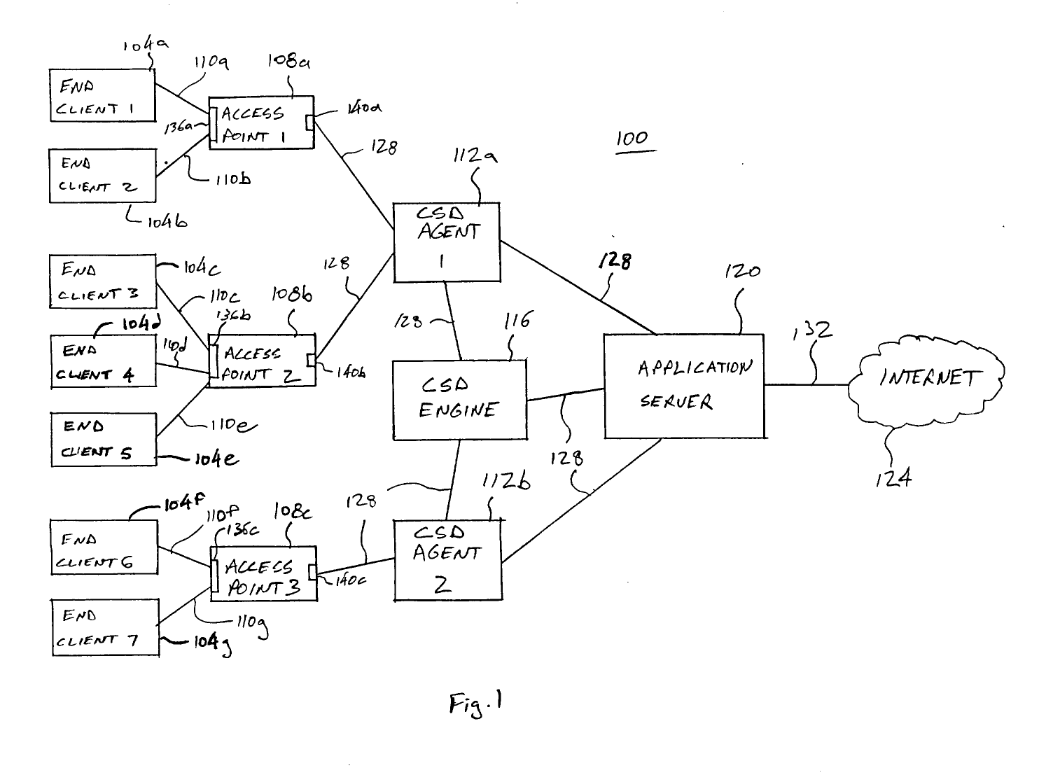

With reference to FIG. 1, a computer network 100 incorporating a dynamic bandwidth allocation system in accordance with an embodiment of the present invention is depicted in block diagram form. As shown in FIG. 1, the network 100 may comprise a plurality of end clients 104 in communication with one or more computer network access points 108 through end client communication links or channels 110. Each access point 108 is in turn interconnected to a central site director agent (CSD agent) 112. As shown in the example network 100 of FIG. 1, more than one central site director agent 112 may be provided, and each central site director agent 112 may be interconnected to one or more access points 108. The central site director agents 112 are in turn interconnected to a central site director engine (CSD engine) 116. The central site director agents 112 are also interconnected to an application or network server 120., In addition, the central site director engine 116 is interconnected to the application server 120. As illustrated in FIG. 1, the application server 120 may be interconnected to additional computer networks, including the Internet 124. In general, an access point 108, central site director agent 112, central site director engine 116, and application server 120, are interconnected by network communication links 128. In accordance with an embodiment of the present invention, the network communication links or channels 128 comprise wireline Ethernet links. However, as can be appreciated, additional or alternative network connection protocols may be used to implement the network communication links 128. An inter-network communication link 132 may interconnect the application or network server 120 to the Internet 124 or other networks.

The end clients 104 may include a variety of terminal or client devices. For example, an end client 104 may include a client computer device, such as a laptop computer, a hand-held computer, a personal digital assistant (“PDA”), a bar code reader, or a cash register or other type of dedicated computing terminal.

The access point 108 generally provides one or more ports to allow one or more end clients 104 to be interconnected to the remainder of the network 100. The client communication link 110 interconnecting an access point 108 to an end client 104 may include a wireless or wire line interconnection. In accordance with an embodiment of the present invention, the client communication link 110 between an end client 104 and an access point 108 has a finite total bandwidth. Examples of an access point 108 include devices having interfaces 136 for establishing proximity-based wireless client communication links 110 in accordance with wireless local area network (WLAN) protocols such as IEEE 802.11, IEEE 802.11a, IEEE 802.11b (WiFi™), Bluetooth™ or HyperLAN™. Other examples of an access point 108 include devices having an interface 136 for establishing client communication links 110 in accordance with Ethernet and other wireline network protocols. In addition, an access point 108 generally includes a network communication link interface 140.

The central site director agent 112 may be interconnected to one or more access points 108 by one or more network communication links 128. Furthermore, as illustrated in FIG. 1, more than one central site director agent 112 may be associated with a network 100. In general, the central site director agent 112 implements and enforces policies that are communicated to the central site director agent 112 from the central site director engine 116. In particular, and as will be described in greater detail below, the central site director agent 112 may monitor one or more network parameters, such as the congestion status at associated access points 108, and may implement bandwidth allocation procedures according to parameters provided by the central site director engine 116. In accordance with an embodiment of the present invention, a central site director agent 112 comprises a general purpose computer, such as a PC computer. For example, a central site director agent 112 in accordance with an embodiment of the present invention comprises a single processor PC computer having a Pentium™ processor and 500 megabytes of RAM.

The central site director engine 116 maintains policies regarding access to the network 100 and regarding the allocation of bandwidth to end clients 104. For example, the central site director engine 116 may maintain policies regarding the priority rating that is assigned to a particular end client 104. In addition, the central site director engine may maintain policies regarding the steps taken to allocate bandwidth to end clients 104 depending upon the particular priority ranking of an end client 104. Also, the central site director engine 116 may maintain and/or implement policies regarding access to the network 100. The central site director engine 116 may comprise a general purpose computer, such as a PC computer. For example, in accordance with an embodiment of the present invention, the central site director engine 116 comprises a dual Pentium™ processor computer having one gigabyte of RAM.

The application server 120 is, in accordance with an embodiment of the present invention, a conventional network server. Accordingly, the application server 120 may comprise a single or multi-processor PC computer. The application server 120 may provide storage space and processor resources in connection with applications running on the network. In addition, the application server 120 may provide links to other networks. For example, as shown in FIG. 1, the application server 120 may provide an interconnection between the computer network 100 and the Internet 124. As can be appreciated, multiple application servers 120 may be associated with the network 100.

As can be appreciated by one of skill in the art, various of the components of the network 100 may be combined. For example, the functions of the central site director agent 112, the central site director engine 116, and the application server 120 may be combined in a single device. As a further example, the functions of the access points 108 may be integrated with, for example, the central site director agent 112. Accordingly, it should be appreciated that the configuration illustrated in FIG. 1 should not be construed as limiting the invention to the embodiment illustrated therein.

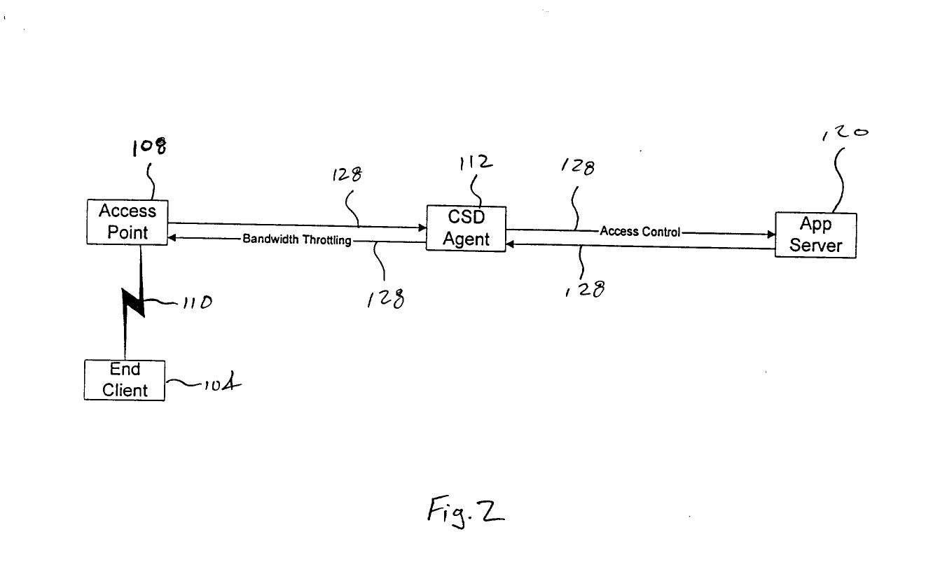

With reference now to FIG. 2, the relationship between various components of a dynamic bandwidth allocation system in accordance with an embodiment of the present invention is shown in block diagram form. In particular, FIG. 2 represents an end client 104 in communication with an access point 108 over a communication link 110. As shown in FIG. 2, the link 110 may comprise a wireless communication link. The access point 108 communicates with the central site director agent 112 to determine whether access to resources available on or through the application server 120 will be provided to the end client 104. If the central site director agent 112, under the policies established in connection with the central site director engine 116 grants such access, the end client 104 is placed in communication with the application server 120 through the central site director agent 112. Data returned by the application server 120 to the end client 104 first passes through the central site director agent 112, where that data is subject to bandwidth control or throttling. For example, if congestion on the network 100, and in particular on the access point 108 interconnecting the end client 104 to the network is detected, the maximum bandwidth available for the transmission of data from the application server 120 to the end client 104 may be limited according to the policies implemented by the central site director agent 112.

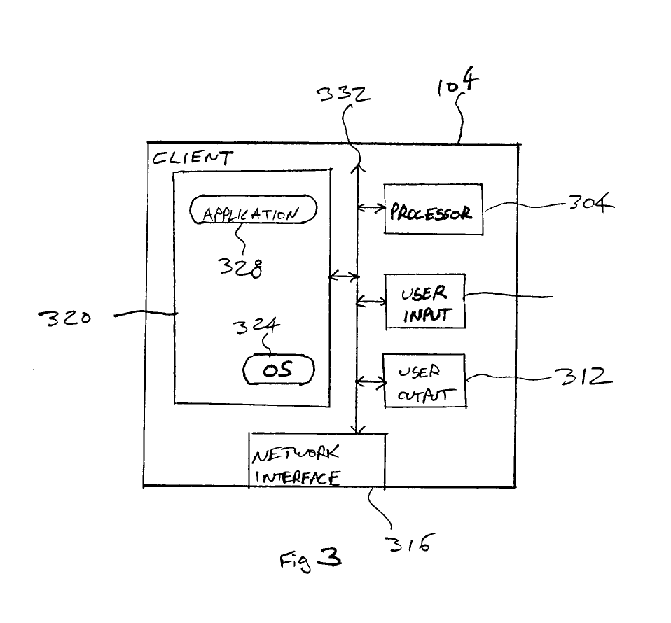

With reference now to FIG. 3, an end client 104 in accordance with an embodiment of the present invention is illustrated in block diagram form. In general, the end client 104 includes a processor 304, a user input 308, and a user output 312. In addition, the end client 104 includes a network interface 316 and data storage 320. The data storage 320 may include, for example, an operating system 324 and one or more application programs 328. The operating system 324 and application 328 will in many cases be dependent upon the particular end client 104. For example, an end client 104 comprising a laptop computer may include a Windows™ operating system 324 and a number of applications 328, such as an Internet browser, an email utility, a word processor and a spreadsheet. As a further example, an end client 104 comprising a PDA may have a Palm™ operating system 324 and applications 328 that include an Internet browser and a calendar. As still another example, an end client 104 comprising a cellular telephone may include a proprietary operating system 324 and an Internet browser application program 328. In addition to general purpose applications 328, an end client 104 may run customized applications. For example, an end client 104 for use in connection with the tracking of baggage or passengers carried by an airline may be especially developed for that purpose.

The various components 304 to 320 of the end client 104 may be interconnected by a communication bus 332. As noted above, the end client 104 may comprise any one of a variety of devices capable of communicating over a computer network 100. Thus, the processor 304 may comprise, for example, a general purpose programmable processor, such as a Pentium™ processor, a digital signal processor, or a controller. The user input 308 may include a keyboard, keypad, pointing device, microphone, barcode reader, magnetic card reader, or personal identification system, such as a retinal scanner or a fingerprint reader. The user output 312 may include a visual display, such as a flat panel display, an audible output, and a printer. Furthermore, it can be appreciated that the user input 308 and user output 312 may be at least partially combined, for example, in connection with a touch screen. Also, it should be appreciated that the user input 308 and the user output 312 may each comprise a plurality of devices.

The network interface 316 provides an interface between the end client 104 and an access point 108. Furthermore, where the client communication link 110 comprises a wireless link, the network interface 316 establishes the client communication link 110 in cooperation with the access point 108. Accordingly, the network interface 316 may comprise a wireless or wire line communication port. For example, the network interface 316 may comprise an IEEE 802.11b (WiFi™) interface to allow wireless communications between the end client 104 and an access point 108. Where the client communication link 110 comprises a wireline connection, the network interface 316 may provide a port or socket. The data storage 320 may comprise a device suitable for storing computer data, such as hard disk drive, or solid state memory. Furthermore, as can be appreciated, different types of storage devices may comprise the storage device 320.

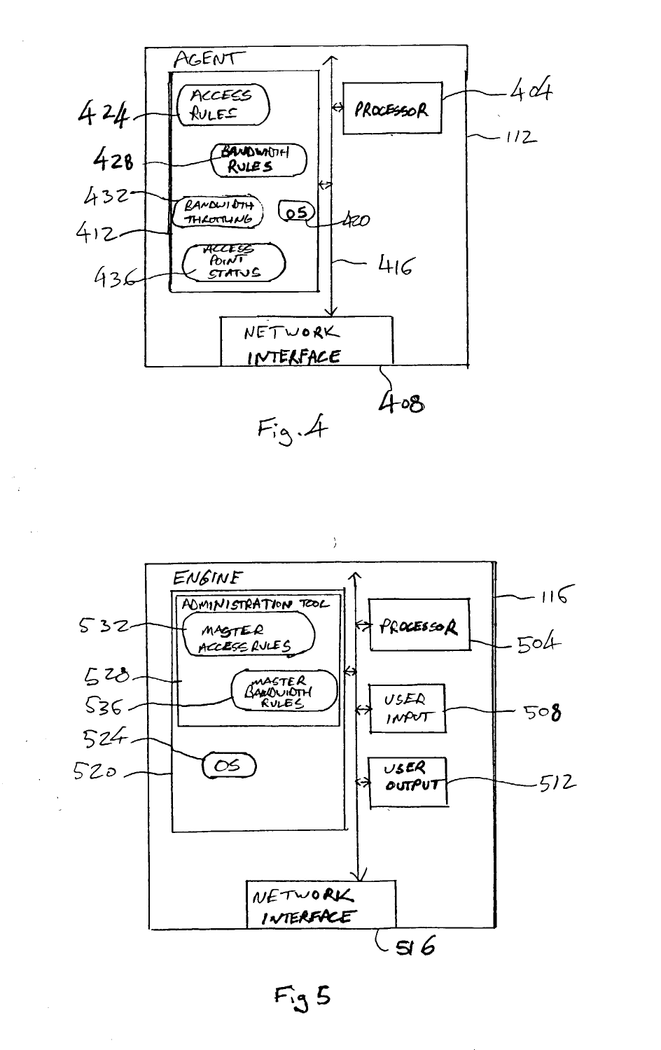

With reference now to FIG. 4, a central site director agent 112 in accordance with an embodiment of the present invention is illustrated in block diagram form. In general, the central site director agent 112 may include a processor 404, a network interface 408 and data storage 412. The various components 404 to 412 of the agent 112 may be interconnected by a communication bus 416. The data storage 412 may have stored thereon a variety of programs and data, including an operating system 420, network access rules 424, bandwidth rules application 428, bandwidth throttling application 432, including a data queuing application or other application for restricting bandwidth to an end client 108, and a network parameter status or access point status application 436.

The processor 404 may include a programmable processor, such as a Pentium™ processor. The network interface 408 allows the central site director agent 112 to be placed in communication with one or more access points 108, the central site director engine 116, and the application server 120. In addition, the network interface 408 allows data to be transferred between an interconnected access point 108 and the application server 120 over the network communication link 128. In accordance with an embodiment of the present invention, the network interface 408 comprises an Ethernet interface.

The data storage device 412 may comprise one or more devices suitable for storing data. For example, the data storage device 412 may include a hard disk drive or solid state memory. In addition, the data storage device 412 may include a number of such devices of various types. As will be described in greater detail below, the various applications 424 to 436 stored in the data storage 412 may be run in connection with the operating system 420 on the processor 404 to provide various functions implementing the bandwidth allocation features of the present invention.

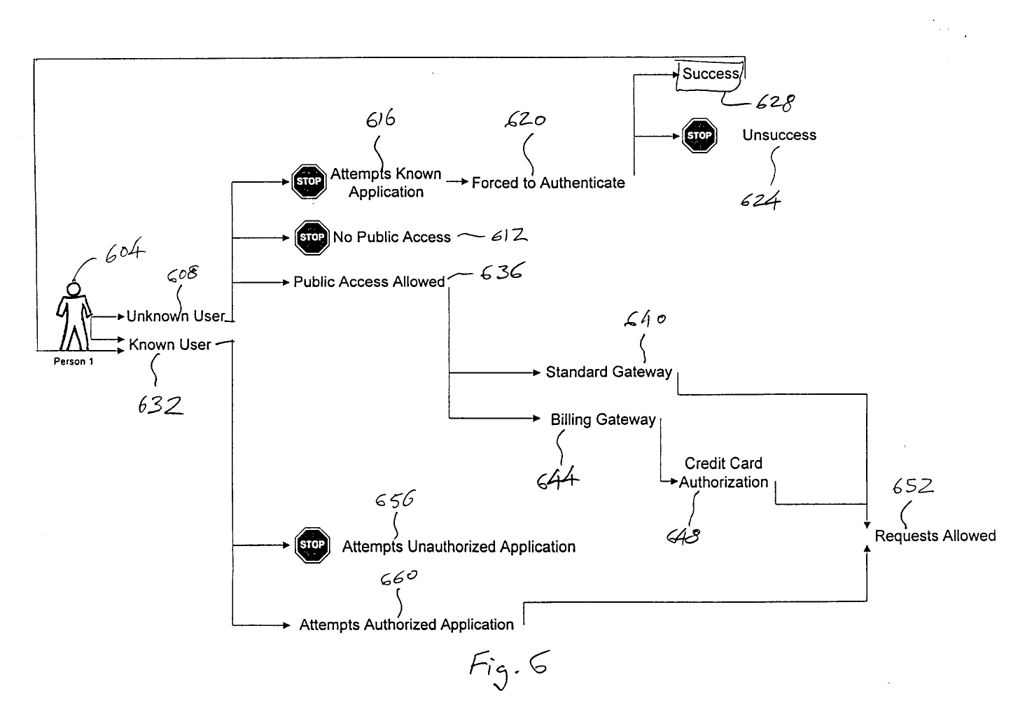

With reference now to FIG. 5, a central site director engine 116 in accordance with an embodiment of the present invention is illustrated in block diagram form. In general, the central site director engine 116 may include a processor 504, a user input 508, and a user output 512. In addition, the central site director engine 116 may include a network interface 516 and data storage 520. The data storage 520 may contain an operating system 524 and an administration tool application 528 in connection with which master access rules 532 and master bandwidth rules 536 may be implemented and maintained.

As noted above, the processor 504 of the central site director engine 116 may comprise one or more general purpose processors, such as Pentium™ processors. The user input 508 may include a keyboard and a pointing device suitable for allowing the central site director engine 116 to receive instructions from an administrator for implementing the rules 532, 536 maintained in connection with the administration tool 528. The user output 512 may comprise a display or other output suitable for facilitating the use of the administration tool 528. Alternatively or in addition to the user input 508 and the user output 512, the user may interact with the administration tool 528 using devices, including an end client 104 or the application server 120, interconnected to the central site director engine 116 through the network interface 516.

The network interface 516 generally allows the central site director engine 116 to be in communication with the central site director agent or agents 112 associated with the network 100, and the application server 120, over the network communication link 128. Accordingly, the network interface 516 may include an Ethernet interface. The data storage 520 may include any device suitable for storing computer data. For example, the data storage 520 may include a hard disk drive or solid state memory. In addition, the data storage 520 may comprise a variety of such devices. The administration tool 528 allows an administrator to enter master access rules 532 and master bandwidth rules 536 that are communicated to the central site director agent or agents 112 to set the policies followed by the central site director agent or agents 112.

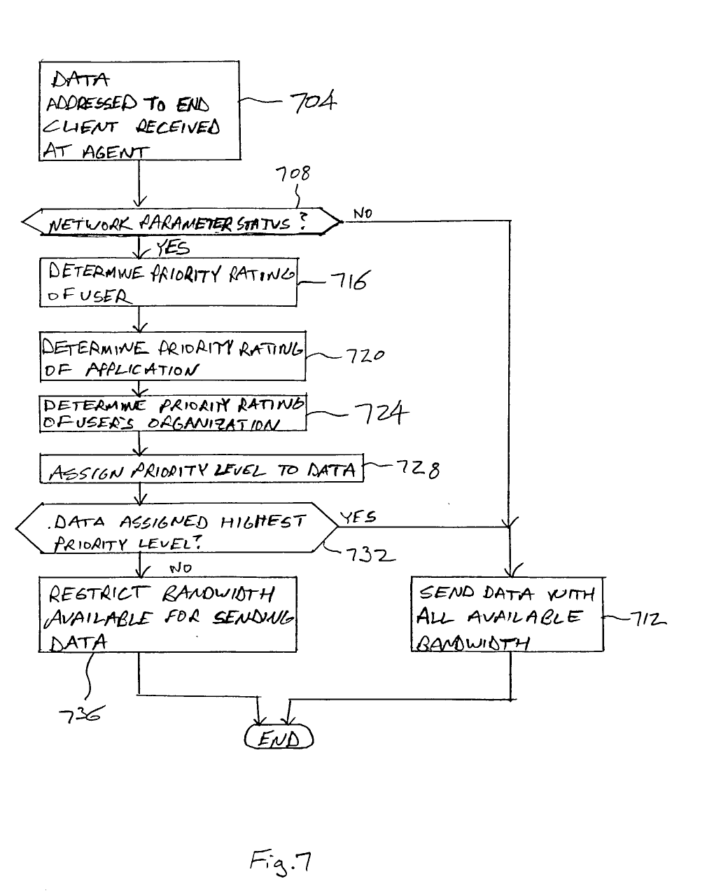

With reference now to FIG. 6, a functional flow diagram depicting access control functions of a bandwidth allocation system in accordance with an embodiment of the present invention is illustrated. In general, a user 604 initiates a request for access to a computer network 100 having an associated dynamic bandwidth allocation system in accordance with an embodiment of the present invention using an end client 104. The user 604 may be known or unknown to the bandwidth allocation system. For example, a user 604 that is associated with a business enterprise that owns or has rights in the network 100 may be treated as a known user. A user 604 that is a member of the public (i.e. is not associated with a business enterprise that owns or has rights in the network 100) may then be treated as an unknown user. As a further example, a user 604 operating an end client 104 running an application 328 that is associated with a business enterprise that owns or has rights in the network may be treated as a known user. According to this further example, a user 604 operating an end client 104 running an application 328 that is not associated with a business enterprise that owns or has rights in the network 100 may be treated as an unknown user.

With continued reference to FIG. 6, if the user 604 is an unknown user 608, that user may be denied access to the network 100. For example, an unknown user 608 may be denied access if the central site director engine 116 is configured to deny public access 612 to the network 100. Alternatively, if an unknown user 608 attempts to run a known application 616 in connection with the network 100, the unknown user 608 may be forced to authenticate their identity 620. If the unknown user 608 is unsuccessful 624, they are denied access to the network 100. If the unknown user 608 is successful 628, the user 604 is interconnected to the system as a known user 632.

If public access to the network 100 is allowed 636, the unknown user 608 may interconnect to the network 100 through one or more gateways. For example, the unknown user 608 may interconnect to the network 100 through a standard gateway 640. Alternatively or in addition, the unknown user 608 may interconnect to the network 100 through a billing gateway 644. If connected through the billing gateway 644, the unknown user 608 may be required to perform a step of credit card authorization 648 or other payment step. Where both standard 640 and billing 644 gateways are available to an unknown user 608, the billing gateway 644 may provide a higher bandwidth than the standard gateway 640. Whether interconnected through a standard gateway 640 or a billing gateway 644, the unknown user 608 interconnected to a system in which public access is allowed 636 may then make requests 652 in connection with the network 100. For example, data from a site on the Internet 124 may be requested.

A user 604 who is interconnected as a known user 632 may be prevented from interacting with the network 100 if the known user 632 attempts to run an unauthorized application 656. Alternatively, if the known user 632 attempts to run an authorized application 660, the known user 632 may then make requests 652 in connection with the network 100. For example, the known user may retrieve or enter data in connection with an application running on an application server 120.

From the above description, it can be appreciated that the present invention may provide a variety of paths through which users 604 can interconnect to a network 100. Furthermore, different gateways may be available to different classes of users 604. As will be described in greater detail herein, the various gateways may provide different levels of service.

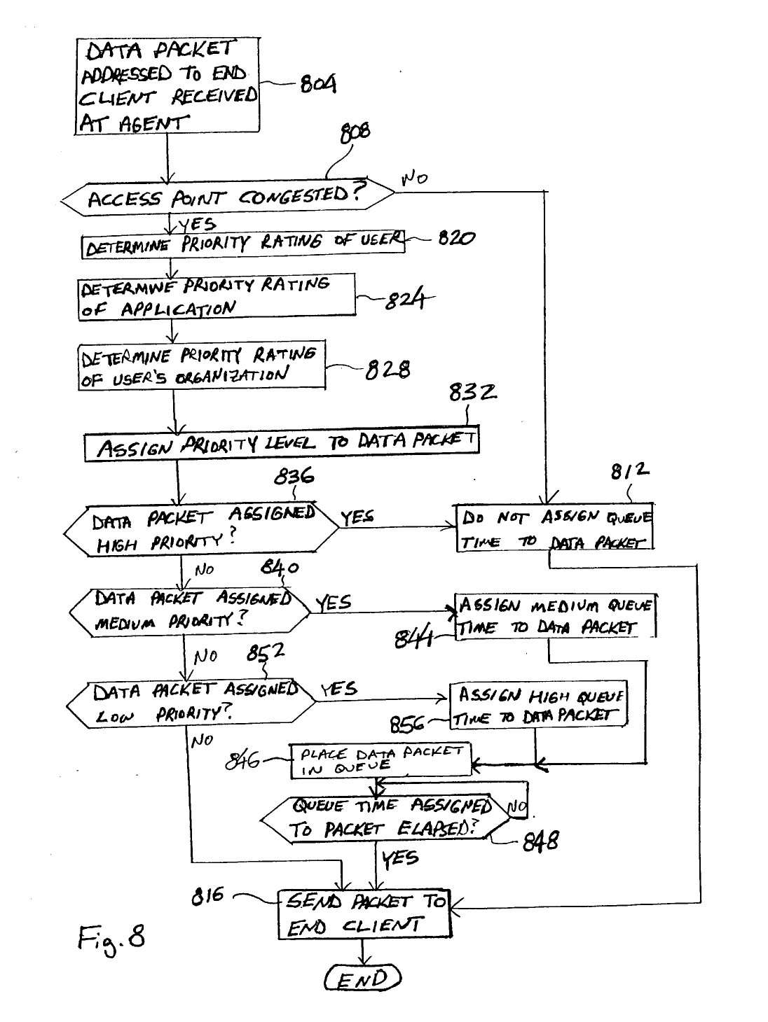

With reference now to FIG. 7, a flow chart depicting the allocation of bandwidth in accordance with an embodiment of the present invention is shown. Initially, data addressed to an end client 104 associated with a user 604 that has successfully interconnected to the network 100 is received at a central site director agent 112 (step 704). In general, the central site director agent 112 receiving the data for an end client 104 is associated with an access point 108 through which the end client 104 in question is interconnected to the network 100. At step 708, the status of a network parameter is determined. In particular, a determination is made as to whether the network 100 is itself congested, or whether the access point 112 through which the end client 104 is interconnected to the network 100 is congested. In accordance with an embodiment of the present invention, the determination of whether an access point 108 is congested is made by the central site director agent 112 associated with the access point 108 in question. Furthermore, the determination of a network parameter status, such as congestion, may be made by the access point status application 436 of a central site director agent 112 by applying rules received from the central site director engine 116. Accordingly, it can be appreciated that the central site director agent 112 associated with the network 100 may implement and enforce rules provided by the central site director engine 116. If it is determined that the access point 108 is not congested, the data is sent to the end client 104 with all available bandwidth (step 712). For example, the data may be sent to the end client 104 using all of the bandwidth then available on the communication link 110 between the end client 104 and the access point 108.

If it is determined that the access point 108 is congested, the priority rating of the user 604 associated with the end client 104 is determined (step 716). The priority rating of a user may be based on whether the user is known or unknown, or on a particular class to which the user 604 belongs. For example, an unknown user 608 who accessed the network 100 through a standard gateway 640 may receive a lower priority rating than an unknown user 608 who accesses the network 100 through a billing gateway 644. In addition, a known user 632 may receive a higher priority rating than an unknown user 608, regardless of the gateway used by the unknown user 608 to access the network 100.

At step 720, the priority rating of the application 328 running on the end client 104 in connection with which the data addressed to the end client 104 is being transmitted is determined. For example, an application 328 that is critical to the operation of a business enterprise operating the network 100 may have a higher priority rating than an application 328 that is peripheral to the operations of that business enterprise. As another example, an application 328 used in connection with real time communications may have a higher priority rating than an application 328 that can better tolerate a delay in receiving data.

At step 724, the priority rating of the user's 604 organization is determined. An example of different priority ratings assigned to different organizations with which a user 604 is associated is in connection with networks 100 shared by different business enterprises. For example, a business enterprise having a large number of transactions occurring within a proximity based network 100 may have a relatively high priority rating with respect to access points 108 in that area. As a further example, a user associated with an emergency services organization, such as a paramedic, may be provided with a high priority rating. As still another example, a public user (i.e. an unknown user 608) or a user associated with a business enterprise having relatively few transactions through an access point 108 may be assigned a relatively low priority rating with respect to the access point 108 in question.

Based on the priority ratings determined in steps 716 to 724, a priority rating or level is assigned to the data (step 728). In accordance with an embodiment of the present invention, the assignment of a priority level to the data at step 728 is made by the bandwidth rules application 428 running on the central site director agent 112 in receipt of the data, in accordance with rules provided by the central site director engine 116. Likewise, the priority ratings determined at steps 716 to 724 are determined by the bandwidth rules application 428 in accordance with rules provided by the central site director engine 116 to the central site director agent 112.

At step 732, a determination is made as to whether the data has been assigned the highest priority level. If the data has been assigned the highest priority level, the data is sent to the end client 104 using all available bandwidth (step 712). If the data has not been assigned the highest priority level, the bandwidth available for sending that data is restricted (step 736). In general, any method of restricting or throttling bandwidth available for sending the data may be utilized. For example, data may be queued, or the size of data frames constructed in connection with the transmission of the data across the network 100 may be altered, as will be described in greater detail below. The determination of whether to restrict bandwidth may be performed by the bandwidth rules application running on the central site director agent 112. The restriction of bandwidth may be performed in connection with the bandwidth throttling application 432 running on the central site director agent 112.

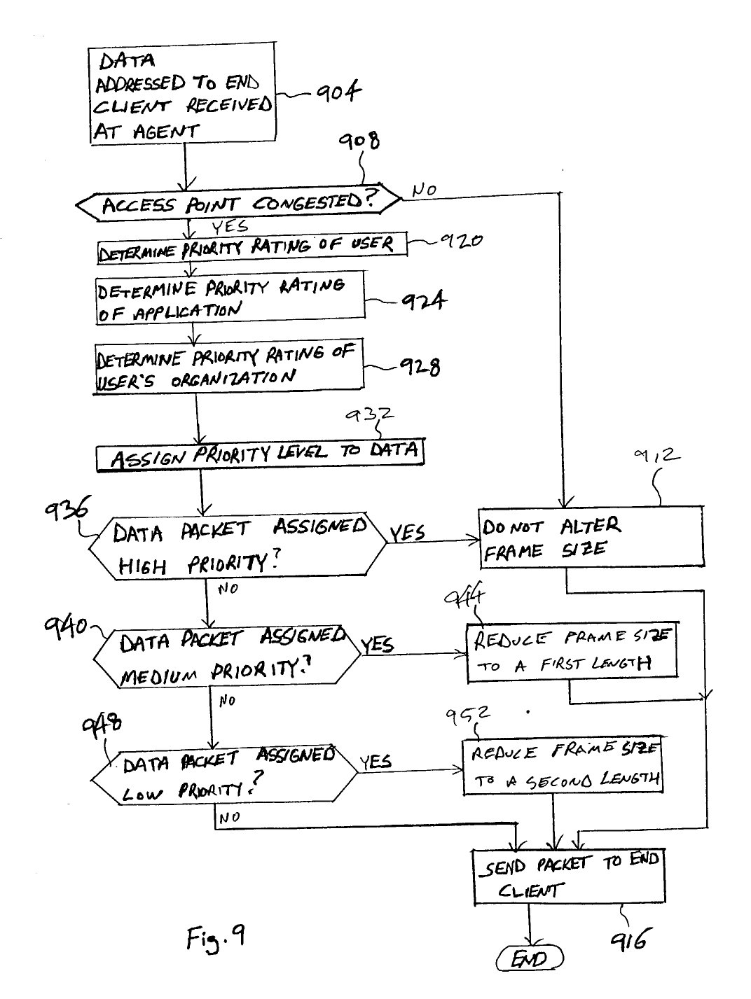

With reference now to FIG. 8, a flow chart depicting the allocation of bandwidth in accordance with another embodiment of the present invention is illustrated. Initially, at step 804, a data packet addressed to an end client 104 is received at a central site director agent 112. At step 808, a determination is made as to whether the access point 108 through which the end client 104 is in communication with the network 100 is congested. If the access point 108 is not congested, a queue time is not assigned to the data packet (step 812). The data packet is then sent to the end client 104 (step 816).

If at step 808 it is determined that the access point 108 is congested, the priority rating of the user is determined (step 820), the priority rating of the application in connection with which the data packet is being sent is determined (step 824), and the priority rating of the user's organization is also determined (step 828). At step 832, a priority rating or level is assigned to the data packet based on the various priority rating determinations that have been made at steps 820 to 828.

At step 836, a determination is made as to whether the data packet has been assigned a high priority. If the data packet has been assigned a high priority, a queue time is not assigned to the data packet (step 812) and the data packet is sent to the end client 104 (step 816).

If the data packet has not been assigned a high priority, a determination is made as to whether the data packet has been assigned a medium priority (step 840). If a medium priority level has been assigned to the data packet, a medium queue time is assigned to that data packet (step 844) and the data packet is placed in a data queue (step 846). In general, the queue time assigned to a data packet represents a minimum wait time that a data packet must complete before it is released for delivery to the end client 104. Accordingly, it can be appreciated that memory may be provided for queuing data packets. For example, in accordance with an embodiment of the present invention, a data packet queue is established in the data storage 412 provided as part of the central site director agent 112. Furthermore, a bandwidth allocation or throttling application comprising a data queuing application 432 running on the central site director agent 112 may control the queuing and release of data packets.

At step 848, a determination is made as to whether the queue time assigned to the data packet has elapsed. In general, monitoring of the amount of time that has elapsed with respect to the queuing of the data packet is performed periodically or continuously. Thus, if the queue time assigned to a data packet has not elapsed, the system returns to step 848. If at step 848 it is determined that the queue time assigned to a data packet has elapsed, the data packet is released for transmission to the end client 104 (step 816).

If at step 840 it is determined that the data packet has not been assigned a medium priority, a determination is made as to whether the data packet has been assigned a low priority (step 852). If a low priority has been assigned to the data packet, a high queue time is assigned to that data packet (step 856). The data packet is then placed in the queue (step 846), and the system proceeds to step 848 to determine whether the queue time assigned to the data packet has elapsed. The data packet is released for transmission to the end client 104 (step 816) after the assigned queue time has elapsed. If at step 852 the data packet has not been found to have a low priority assignment, it is simply sent to the end client (step 816).

From the description provided in connection with FIG. 8, it is apparent that data packets having a relatively high priority are not required to sit idle in a queue for any minimum amount of time. Accordingly, data packets having a high priority may be sent to an end client 104 as quickly as the network 100 is able to send that data packet. That is, a data packet having a high priority is sent to the end client 104 with the maximum available bandwidth. As can be appreciated, when the access point 108 is congested, the rate at which an end client 104 receives data may be less than the theoretical maximum available data rate, due to the high level of traffic. However, it will be appreciated that the data rate is not artificially limited by the system in connection with high priority packets.

It will also be appreciated that, in connection with low priority data packets, the rate at which such packets are released to the end client 104 is limited when the access point 108 through which the data packets will be sent to the end client 104 is congested. That is, low priority data packets are required to sit idle in a data queue for at least a minimum specified queue time before that data is sent to an end client 104. Accordingly, the proportion of the total bandwidth that can be occupied by a stream of low priority data packets is limited by the implementation of a relatively high queue time. This leaves the remainder of the available bandwidth available for higher priority data packets.

As can also be appreciated from the description provided in connection with FIG. 8, medium priority data packets are required to wait in a data queue for at least an intermediate period of time when the access point 108 through which the data packets will be provided to the end client 104 is congested. This limits the proportion of the total bandwidth available that can be occupied by medium priority data packets. In particular, the proportion of total bandwidth that can be occupied by a given number of medium priority data packets is greater than the total proportion that can be occupied by a given number of low priority data packets.

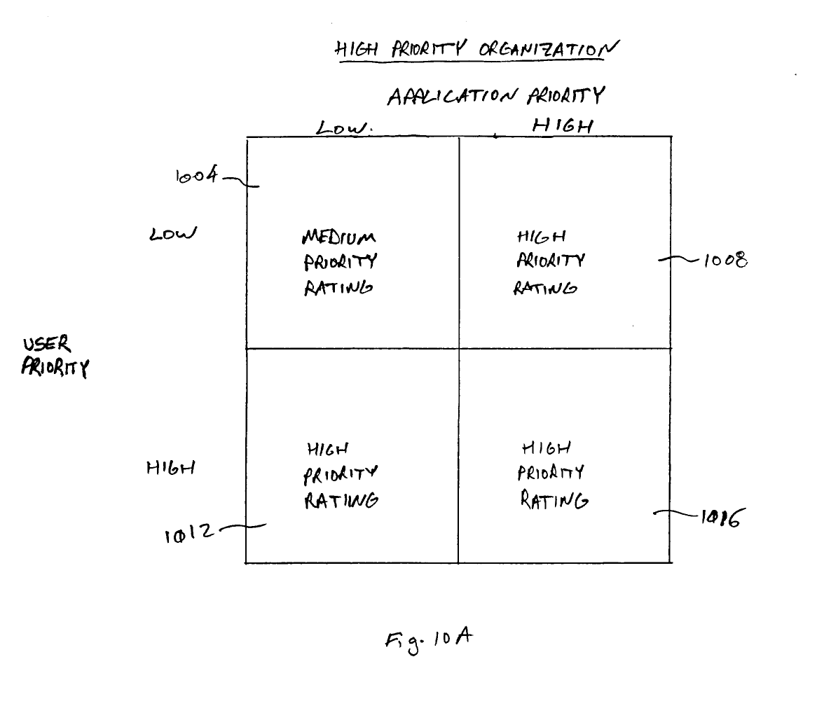

With reference now to FIG. 9, a flow chart depicting the allocation of bandwidth in accordance with still another embodiment of the present invention is illustrated. Initially, at step 904, a data packet addressed to an end client 104 is received at a central site director agent 112. At step 908, a determination is made as to whether the access point 108 through which the end client 104 is interconnected to the network 100 is congested. If the access point 108 is not congested, the frame size of the data packet is not altered (step 912) and the data packet is sent to the end client 104 (step 916).

If the access point 108 is congested, the priority rating of the user associated with the end client 104 is determined (step 920). The priority rating of the application 328 running on the end client 104 is also determined (step 924). In addition, the priority rating of the user's organization is determined (step 928). Based on the priority ratings determined at steps 920 to 928, a priority rating or level is assigned to the data packet (step 932). In accordance with an embodiment of the present invention, the determinations of priority ratings to a data packet is performed by the central site director agent 112, implementing rules provided by the central site director engine 116.

At step 936, a determination is made as to whether that data packet has been assigned a high priority. If the data packet has been assigned a high priority, the frame size of the data packet is not altered (step 912), and the data packet is sent to the end client (step 916).

If the data packet has not been assigned a high priority, a determination is made as to whether the data packet has been assigned a medium priority (step 940). If the data packet has been assigned a medium priority, the frame size is reduced to a first length (step 944). The data is then sent to the end client 104 in packets of the first length (step 916). As can be appreciated by one of skill in the art, reducing the frame size or length increases the number of packets required to send a given quantity of data. Because each frame of data has an associated interframe gap, sending a quantity of data in a larger number of frames provides a greater number of interframe gaps, which can be used by the central site director agent 112 to initiate the transmission of other data packets to other clients 104. Accordingly, forcing a quantity of data into a relatively large number of data packets results in a generally lower transmission rate for that data than if fewer packets were used, while making it more likely that data packets being sent to another client 104 can be transmitted.

If the data packet has not been assigned a medium priority, a determination is made as to whether the data packet has been assigned a low priority (step 948). If the data packet has been assigned a low priority, the frame size is reduced to a second length that is smaller than the first length (step 952). The data packet is then sent to the end client (step 916). If at step 948 it is determined that the data packet has not been assigned a low priority, the data packet is sent to the end client 104 with the frame length unaltered (step 916).

As can be appreciated, by manipulating the frame size or length of data packets, the bandwidth with which the data is provided to the end client 104 can be manipulated. In particular, high priority data packets can be provided to an end client 104 without any artificial delay. Furthermore, the transmission of high priority data can be favored at the expense of increasing the time required to transmit lower priority data.

As an alternative to altering the size of frames used to transmit data, the bandwidth available for the transmission of data can be controlled by altering the receive window size associated with an end client 104. In particular, a higher effective bandwidth can be provided for the transmission of data to an end client 104 by increasing the receive window size used by that end client 104. As a further alternative, the size of data packets sent to an end client 104 and/or the receive window associated with the end client 104 can be manipulated so that the receive window is sized to equal a multiple of the maximum transmission units used in sending packets of data.

As can be appreciated from the description provided herein, a network 100 including a bandwidth allocation system in accordance with the present invention is capable of preserving bandwidth for high priority users and/or applications. Furthermore, a network bandwidth allocation and access system in accordance with the present invention allows data packets associated with low priority users and/or applications to be sent at the maximum available bandwidth when the network is not congested. Accordingly, the present invention allows a network 100 to be shared by various users, and allows all available bandwidth to be utilized, while preserving that bandwidth for high priority uses when demand for that bandwidth is great (i.e. when the network is congested).

As can further be appreciated, the definition of congestion at an access point 108 or otherwise associated with the network 100 may be defined in various ways. For example, congestion may be determined by a total data rate flowing through an access point 108. Alternatively or in addition, network congestion may be defined in connection with a number of end clients 104 interconnected to a single access point 108. Congestion at an access point 108 may also be defined in connection with a number of applications 328 that are utilizing network 100 resources and that are interconnected to the network 100 through end clients 104 in communication with the access point. Furthermore, the determination to throttle bandwidth can be made in response to network status parameters other than congestion at an access point 108.

As can also be appreciated, bandwidth may be throttled with respect to at least some end clients 104 interconnected to a network 100 through a first access point 108 at the same time that bandwidth is not artificially restricted with respect to end clients 104 interconnected to the network 100 through a second access point 108. Furthermore, the first and second access points 108 in the present example can be interconnected to the same central site director agent 112, or the first and second access points can be interconnected to different central site director agents 112.

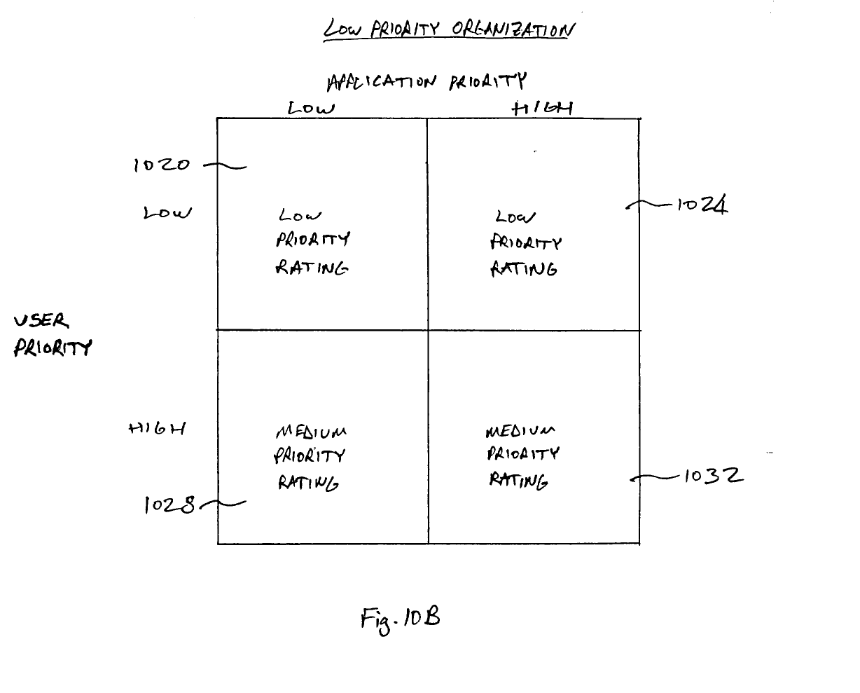

With reference now to FIGS. 10A and 10B, tables for determining a priority level of a data packet in accordance with an embodiment of the present invention are illustrated. As shown in FIGS. 10A and 10B, different combinations of priority ratings based on various aspects of a data packet can be blended to provide an overall data packet priority level. For example, in FIG. 10A, various data packet priority ratings that are assigned in connection with an end client 104 having a high priority organization rating are illustrated. In particular, a medium priority rating is assigned to a data packet having a low user priority, a low application priority, and a high organization priority 1004. A high priority rating is associated with an end client 104 having a low user priority, a high application priority, and a high organization priority 1008. A high priority rating is also assigned to a data packet having a high user priority, a low application priority, and a high organization priority 1012. Furthermore, a high priority rating is assigned to a data packet being sent to an end client 104 having a high user priority, a high application priority, and a high organization priority 116.

In FIG. 10B, various priority ratings assigned to data packets being sent to end clients 104 having a low organization priority are illustrated. In particular, a data packet being sent to an end client 104 having a low user priority, a low application priority, and a low organization priority is assigned a low priority rating 1020. A data packet being sent to a end client 104 having a low user priority, a high application priority, and a low organization priority also receives a low priority rating 1024. A data packet being sent to an end client 104 having a high user priority, a low application priority, and a low organization priority, receives a medium priority rating 1028. A data packet being sent to an end client 104 having a high user priority, a high application priority, and a low organization priority also receives a medium priority rating 1032.

The rules for assigning priority ratings based on the various aspects of a data packet, and on arriving at an overall priority level assigned to the data packet, may be implemented in connection with the central site director engine 116. In particular, an administrator may utilize the administration tool 528 provided in connection with the central site director engine 116 for assigning a priority level to a data packet.

Although in FIGS. 10A and 10B three different priority levels based on three different priority ratings associated with aspects of a data packet, each having two assignable levels, is shown, it can be appreciated that various combinations are possible. Fewer or additional or alternative aspects associated with the data packet may be considered. Furthermore, more than two levels may be associated with the aspects considered. In addition, more than three priority ratings may be assigned to a data packet based on the associated considerations. Furthermore, it can be appreciated that the rules maintained by the central site director engine 116 and implemented by the central site director agent 112 can be modified to accommodate various factors in determining priority ratings assigned to data packets and to implement various schemes for dynamically allocating bandwidth.

The foregoing discussion of the invention has been presented for purposes of illustration and description. Further, the description is not intended to limit the invention to the form disclosed herein. Consequently, variations and modifications commensurate with the above teachings, within the skill and knowledge of the relevant art, are within the scope of the present invention. The embodiments described hereinabove are further intended to explain the best mode presently known of practicing the invention and to enable others skilled in the art to utilize the invention in such or in other embodiments and with various modifications required by their particular application or use of the invention. It is intended that the appended claims be construed to include the alternative embodiments to the extent permitted by the prior art.

What is claimed is:

1. A method for controlling bandwidth, comprising:
identifying a first end client of a computer network;
identifying a second end client of said computer network;
determining a status of a parameter of said network;
in response to determining a first network parameter status, providing a first bandwidth to said first end client; and
in response to determining said first network parameter status, providing a second bandwidth to said second end client.

2. The method of claim 1, further comprising:
in response to determining a second network parameter status, providing said first bandwidth to said first end client;
in response to determining said second network parameter status, providing said first bandwidth to said second end client.

3. The method of claim 2, wherein said first network parameter status comprises a congested network status, and wherein said second network parameter status comprises an uncongested network status.

4. The method of claim 2, wherein said first network parameter status comprises a congested network access point and wherein said second network parameter status comprises an uncongested network access point.

5. The method of claim 4, wherein said congested network access point has at least a first number of end clients interconnected to said network access point, and wherein said uncongested network access point has less than said first number of end clients interconnected to said network access point.

6. The method of claim 1, wherein said first end client is associated with a first application and wherein said second end client is associated with a second application.

7. The method of claim 1, wherein said first end client has a first priority rating, and wherein said second end client has a second priority rating.

8. The method of claim 7, wherein said first priority rating comprises at least one of a first user priority rating, a first application priority rating, and a first user organization priority rating, and wherein said second priority rating comprises at least one of a second user priority rating, a second application priority rating, and a second user organization priority rating.

9. The method of claim 1, wherein said first end client is associated with a known user, and said second end client is associated with an unknown user.

10. The method of claim 1, wherein said computer network comprises a wireless communication link to said first end client and to said second end client.

11. The method of claim 1, further comprising:
prior to said step of delivering a packet of data to said second end client, receiving payment from said second end client.

12. The method of claim 1, wherein said first bandwidth comprises a first maximum bandwidth and wherein said second bandwidth comprises a second maximum bandwidth.

13. The method of claim 1, wherein said second bandwidth is limited to a second maximum bandwidth by interposing a first delay period before delivering a packet of data to said second end client.

14. The method of claim 13, wherein said first delay period is predetermined.

15. The method of claim 1, wherein said second bandwidth is limited to said second maximum bandwidth by altering a frame length of a data packet addressed to said second end client.

16. The method of claim 1, wherein said second bandwidth is limited to said second maximum bandwidth by altering a receive window size associated with said second end client.

17. A method of controlling bandwidth on a computer network, comprising:
receiving from a first end client a request for access to said network;
determining a priority rating of said first end client;
receiving from a second end client a request for access to said network;
determining a priority rating of said second end client;
determining a congestion status of said network; and
in response to determining a first congestion status, providing a first bandwidth to said first end client and providing a second bandwidth to said second end client, wherein said first end client has a first priority rating and said second end client has a second priority rating.

18. The method of claim 17, wherein said congestion status of said network comprises a congestion status of a network access point.

19. The method of claim 17, further comprising:
in response to determining a second congestion status, providing said first bandwidth to said first end client and providing said first bandwidth to said second end client.

20. The method of claim 17, wherein said first bandwidth comprises a first maximum bandwidth and wherein said second bandwidth comprises a second maximum bandwidth.

21. The method of claim 17, wherein said first bandwidth is greater than said second bandwidth.

22. The method of claim 17, wherein said steps of determining a priority rating of a respective end client comprises determining at least one of a user priority rating, an application priority rating, and a user organization rating associated with said respective end client.

23. The method of claim 17, wherein said first end client is associated with a known user and wherein said second network client is associated with an unknown user.

24. The method of claim 17, wherein said network and said first end client are associated with a common enterprise, and wherein said second end client is a public user.

25. A computer readable storage medium carrying instructions for performing a method, the method comprising:
identifying a first end client of a computer network;
identifying a second end client of said computer network;
determining a status of a parameter of said network;
in response to determining a first network parameter status, providing a first bandwidth to said first end client; and
in response to determining said first network parameter status, providing a second bandwidth to said second end client.

26. The computer readable storage medium of claim 25, the method further comprising:
in response to determining a second network parameter status, providing said first bandwidth to said first end client;
in response to determining said second network parameter status, providing said first bandwidth to said second end client.

27. The computer readable storage medium of claim 26, wherein said first network parameter status comprises a congested network access point, and wherein said second network parameter status comprises an uncongested network access point.

28. The computer readable storage medium of claim 27, wherein said congested network access point has at least a first number of applications in communication with said computer network through said congested network access point, and wherein said uncongested network access point has less than said first number of application in communication with said computer network through said uncongested network access point.

29. The computer readable storage medium of claim 25, wherein said first end client is associated with a first application and wherein said second end client is associated with a second application.

30. The computer readable storage medium of claim 25, wherein said first end client has a first priority rating, and wherein said second end client has a second priority rating.

31. The computer readable storage medium of claim 30, wherein said first priority rating comprises at least one of a first user priority rating, a first application priority rating, and a first user organization priority rating, and wherein said second priority rating comprises at least one of a second user priority rating, a second application priority rating, and a second user organization priority rating.

32. The computer readable storage medium of claim 25, wherein said first end client is a known user, and said second end client end is an unknown user.

33. The computer readable storage medium of claim 25, wherein said computer network comprises a wireless communication link to said first end client and to said second end client.

34. The computer readable storage medium of claim 25, the method further comprising:
prior to said step of delivering a packet of data to said second end client, receiving payment from said second end client.

35. The computer readable storage medium of claim 25, wherein said first bandwidth comprises a first maximum bandwidth and wherein said second bandwidth comprises a second maximum bandwidth.

36. The computer readable storage medium of claim 25, wherein said second bandwidth is limited to a second maximum bandwidth by interposing a first delay period before delivering a packet of data to said second end client.

37. The computer readable storage medium of claim 25, wherein said second bandwidth is limited to a second maximum bandwidth by altering a frame size of a data packet addressed to said second end client.

38. The computer readable storage medium of claim 25, wherein said second bandwidth is limited to a second maximum bandwidth by altering a receive window size associated with said second end client.

39. An apparatus for controlling bandwidth in a computer network, comprising:
at least a first computer data storage device, wherein program instructions related to an amount of bandwidth provided to an end client are stored on said storage device;
at least a first network access point, wherein an end client may interconnect to said network through said network access point; and
at least a first processor interconnected to said network, said processor capable of executing said program instructions related to an amount of bandwidth provided to an end client, wherein in connection with a congested network a first end client is presented with a first bandwidth and a second end client is provided with a second bandwidth, and wherein said second bandwidth is less than said first bandwidth.

40. The apparatus of claim 39, wherein in connection with an uncongested network said first end client and said second end client are provided with said first bandwidth.

41. The apparatus of claim 39, further comprising:
a data packet storage queue, wherein said second bandwidth is provided to said second end client by holding a packet of data in said queue for at least a first predetermined period of time before transmission of said packet of data to said second end client.

42. The apparatus of claim 39, wherein said second bandwidth is provided to said second client by altering a frame length of a data packet addressed to said second end client.

43. The apparatus of claim 39, wherein said first network access point comprises a wireless access point.

44. The apparatus of claim 39, further comprising:
an end client interconnected to said network by said at least a first access point.

45. The apparatus of claim 40, wherein said congested network comprises a computer network having at least a first number of end clients interconnected to said at least a first network access point, and wherein said uncongested network comprises a computer network having less than said first number of end clients interconnected to said at least a first network access point.

46. An apparatus for controlling bandwidth in a computer network, comprising:
means for determining a priority rating of an end client;
means for determining a network parameter status;
means for allocating a first bandwidth to an end client having a first priority rating in response to detecting a first network parameter status or a second network parameter status; and
means for allocating said first bandwidth to an end client having a second priority rating in response to detecting said first network parameter status and for allocating a second bandwidth to said end client having a second priority rating in response to detecting said second network status, wherein said first bandwidth is greater than said second bandwidth.

47. The apparatus of claim 46, wherein said priority rating of an end client is dependent on at least one of a user priority rating, an application priority rating, and a user organization rating associated with said end client.

48. The apparatus of claim 46, further comprising:
means for wirelessly interconnecting said end client to said computer network.

49. A computer network having dynamic bandwidth control, comprising:
a network server, comprising:
a computer data storage device, having programming code for providing dynamic bandwidth control stored thereon;
a processor capable of executing said programming code;
a communication channel interconnected to said network server, said communication channel comprising at least first and second segments;
at least a first computer network access point interconnected to said network server by a first segment of said communication channel;
a first end client interconnected to said network access point by said second segment of said communication channel, wherein said second communication channel is capable of transmitting data packets, wherein said first end client is provided with a first bandwidth when said network is uncongested, and wherein said first end client is provided with a second bandwidth when said network is congested; and
a second end client interconnected to said network access point by at least one of said second segment of said communication channel and a third segment of said communication channel, wherein said second end client is provided with said first data bandwidth when said network is uncongested and when said network is congested.

50. The computer network of claim 49, wherein said first bandwidth is equal to a total available bandwidth available on said second communication channel.

51. The computer network of claim 49, wherein said first computer network access point comprises a wireless computer network point.

52. The computer network of claim 49, further comprising data storage, wherein data is selectively queued in said data storage.

53. The computer network of claim 49, wherein said network is congested when said at least a first computer network access point is congested.
